(19) United States
(12) Patent Application Publication
(10) Pub. No.: US 2003/0028646 A1
(43) Pub. Date: Feb. 6, 2003

(54) Method of establishing a secure data connection

(76) Inventor: Michael John Wray, Bath (GB)

Correspondence Address: HEWLETT-PACKARD COMPANY, Intellectual Property Administration, P.O. Box 272400, Fort Collins, CO, 80527-2400, US

(21) Appl. No.: 10/202,250

(22) Filed: Jul. 24, 2002

(30) Foreign Application Priority Data
Jul. 31, 2001 (GB) 0118674.1

(51) Int. Cl. G06F 15/16

(52) U.S. Cl. 709/227

(57) ABSTRACT

In a method of establishing a data connection between a client computer and a destination computer over a computer network, a first computer network comprises a local area network (LAN) to which is connected a first, second and third client computer. At the boundary of the first computer network is provided a first firewall computer which is connected to the LAN. The first firewall computer is a secure relay computer. A second computer network comprises a web-site server and a second firewall computer which acts in much the same way as the first firewall computer. The second firewall computer only permits incoming data connections if an SSL data connection is used. The second computer network is connected to the first computer network by means of a public network, in this case the Internet. Each of the first, second and third client computers is able to access a website stored on the web-site server. This is achieved by specifying the URL of the web-site, whereafter a protocol is used to establish the connection with the web-site server. By using the protocol, no prior knowledge of the number of secure relays between the client computers and the web-site server is required.

### FIELD OF THE INVENTION

This invention relates to a method of establishing a data connection between computing devices over a computer network.

### BACKGROUND OF THE INVENTION

The recent increase in use of publicly accessible computer networks, such as the Internet, has resulted in an increased need for secure data connections across such networks. This is particularly evident given that there has recently been a large increase in E-commerce facilities on the Internet. Such facilities generally enable confidential business information, financial information, and even payment requests to be sent over publicly accessible computer networks.

The SSL protocol (sometimes called the Transport Level Security (TLS) protocol) is an industry standard method by which secure data connections can be established. The SSL protocol provides data encryption, server authentication, message integrity and optional client authentication over computer networks. SSL is a so-called transport layer protocol since it is defined to operate on the ‘sockets’ level of a computer network. It will be understood by those skilled in the art that ‘sockets’ is the standard application program interface (API) by which data is transferred on the transport level of a computer network. As a result of SSL operating on the sockets level of a network, there must be an end-to-end direct connection between networked devices in order for SSL to function correctly.

It is common for so-called ‘relay’ devices to be located on a computer network. In their simplest form, relays simply receive data from one computer, copy the data, and then forward the data to some destination computer. A ‘firewall’ is one example of a relay, this type of relay also acting as a security device for controlling access to and from computers within a defined network (e.g. the network of a private company).

It has been proposed to use the SSL protocol when sending a message to a so-called ‘secure relay’. A relay is ‘secure’ if it requires access requests (i.e. a message requesting access to a computing device via the relay) to be made over a secure data link. This proposal assumes that the number of secure relays in the path between the source computer and the destination computer is known, before any connection is established, so that an appropriate number of SSL sessions can be set-up. In situations where the destination computer is referenced by its address, e.g. its Uniform Resource Location (URL) address, there is no information concerning the number of relays (some of which may be secure relays) which have to be traversed in order to reach the destination.

### SUMMARY OF THE INVENTION

According to a first aspect of the present invention, there is provided a method of establishing a data connection between a client computer and a destination computer over a computer network containing an unknown number of secure relays, the destination computer being identified at the client computer by an address, wherein the method comprises: (a) establishing data connections between successive connection points to form a connection path from the client computer to the destination computer, (b) in the event that a connection point in the path is a secure relay, using a secure data transfer protocol to supply the address to that connection point for onward transmission; and (c) repeating step (b) for any further secure relay in the connection path until the destination computer is reached.

A ‘secure relay’ is defined as a relay which requires data connection requests to be transferred to it using a secure data transfer protocol. ‘Firewalls’ and ‘proxies’ are examples of relays.

The method provides a means by which a client computer can establish data communications with a remote destination computer via a network which comprises an unknown number of secure relays.

Preferably, in step (b), if the connection point in the path is a secure relay, that secure relay sends a request message to the client computer requesting a secure data transfer session between the client computer and that secure relay, and in response thereto, the client computer may establish a secure data transfer session with that secure relay. In this case, the secure relay effectively informs the client computer that it is a secure relay.

In step (b), if the connection point in the path is a secure relay, and a secure data transfer session has previously been established between the client computer and a secure relay forming a previous point in the path, the client computer may establish a further secure data transfer session between the client computer and the subsequently located secure relay.

When the destination computer is reached, the destination computer may send an acknowledgement message back to the client computer, whereafter the client computer can establish a further secure data transfer session between the client computer and the destination computer. Whereas any previous secure data transfer session would probably have been set up in order to traverse one or more secure relays, this further secure data transfer session can be use to effect secure communications with the destination computer. This is particularly useful if the destination computer is, say, an E-commerce server, perhaps hosting a banking service or offering goods for sale in return for secure payment orders.

The method may further comprise determining whether a secure data transfer session has been previously been established between the client computer and the destination computer; and, in the event that such a secure data transfer session has previously been established, closing the most recently established secure data transfer session and commanding the client computer to transfer data using the previously established secure data transfer session. Reuse of previously established secure data transfer sessions is therefore provided.

The address at the client computer which identifies the destination computer may be in the form of a URL. The secure data transfer protocol is preferably the SSL protocol.

According to a second aspect of the invention, there is provided a method of establishing a data connection between a client computer and a destination computer over a computer network containing an unknown number of secure relays, the destination computer being identified at the client computer by an address, wherein the method comprises: (a) establishing data connections between successive connection points to form a connection path from the client computer to the destination computer; (b) in the event that a connection point in the path is a secure relay: (i) sending a request message to the client computer requesting a secure data transfer session between the client computer and that secure relay, (ii) establishing a secure data transfer session between the client computer and that secure relay, and (iii) using the established secure data transfer session to supply the address to that secure relay for onward transmission; and (c) repeating step (b) for any further secure relay in the connection path until the destination computer is reached.

According to a third aspect of the invention, there is provided a method of establishing a data connection between a client computer and a destination computer over a computer network containing an unknown number of secure relays, the destination computer being identified at the client computer by an address, wherein the method comprises: (a) establishing data connections between successive connection points to form a connection path from the client computer to the destination computer; (b) in the event that a connection point in the path is a secure relay: (i) sending a request message to the client computer requesting a secure data transfer session between the client computer and that secure relay, (ii) establishing a secure data transfer session between the client computer and that secure relay, and (iii) using the established secure data transfer session to supply the address to that secure relay for onward transmission, the secure data transfer session being layered over any previously established secure data transfer session between the client computer and a secure relay forming a previous point in the path; and (c) repeating step (b) for any further secure relay in the connection path until the destination computer is reached.

According to a fourth aspect of the present invention, there is provided a computer program stored on a computer usable medium, the computer program including computer readable instructions for causing a client computer to establish a data connection with a destination computer over a computer network containing an unknown number of secure relays, the destination computer being identified at the client computer by an address, the computer program causing the client computer to perform the steps of: (a) causing data connections to be established between successive connection points to form a connection path from the client computer to the destination computer, (b) in the event that a connection point in the path is a secure relay, using a secure data transfer protocol to supply the address to that connection point for onward transmission; and (c) repeating step (b) for any further secure relay in the connection path until the destination computer is reached.

### BRIEF DESCRIPTION OF THE DRAWINGS

The invention will now be described, by way of example, with reference to the accompanying drawings, in which:

FIG. 1 is a block diagram of a computer network; and

FIG. 2 illustrates the processes running on the computer network shown in FIG. 1.

### DETAILED DESCRIPTION OF A PREFERRED EMBODIMENT

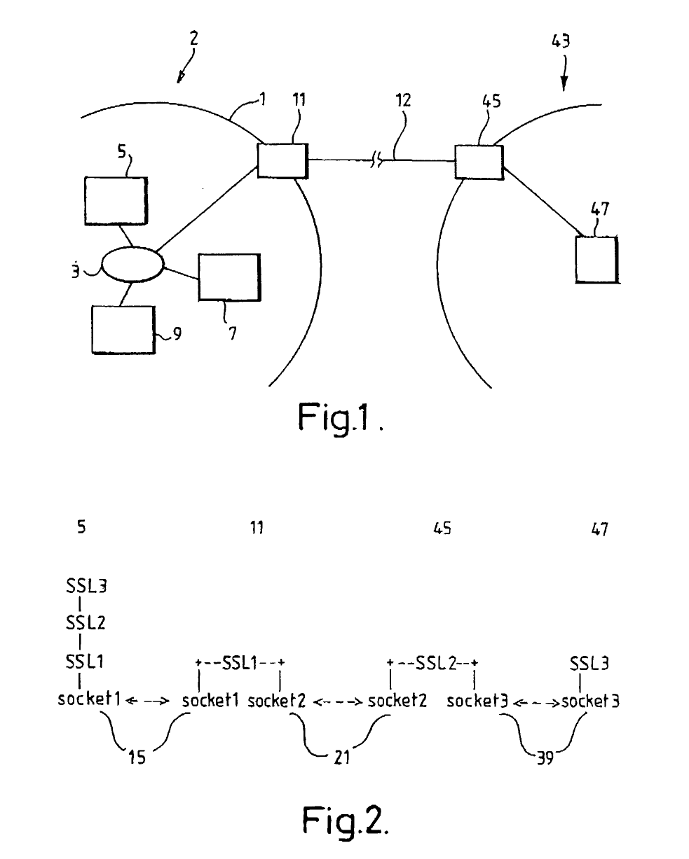

Referring to FIG. 1, a first computer network 1 comprises a local area network (LAN) 3 to which is connected first, second and third client computers 5, 7, and 9. At the boundary of the first computer network 1 is provided a first firewall computer (hereinafter referred to as ‘the first firewall’) 11 which is connected to the LAN 3. The first firewall 11 is a secure relay computer which is configured to prevent all incoming data connections (i.e. external to the first computer network 1) being made, and to control outgoing data connections in accordance with a predefined set of criteria. For example, the predefined set of criteria may prevent data connections being made with the web-sites of competitor companies. The first firewall computer 11 is a ‘secure’ relay computer in that any connection request made to it (i.e. a request to connect to an external computer) can only be accepted and considered if the request is made using a secure data transfer protocol, in this case SSL.

A second computer network 43 is also shown in FIG. 1. This second computer network 43 comprises a web-site server 47 and a second firewall computer (hereinafter referred to as ‘the second firewall’) 45 which acts in much the same way as the first firewall 11. The second firewall 45 is a secure relay and only permits incoming data connections if an SSL data connection is used.

The second computer network 43 is connected to the first computer network 1 by means of a public network, in this case the Internet. The connecting line (represented by reference numeral 12) denotes this Internet connection.

In use, a user of the LAN 3 may wish to access the web-site server 47, for example, to view a web-site and to make a transaction (e.g. to buy a product). The user will usually only be provided with the web-site address specifying the address of the web-site on the web-site server 47. This address is known as its URL. As a general point, and as will be appreciated by those skilled in the art, the route between a source and destination computer is established by means of an Internet browser decoding the URL in order to find the Internet server on which the website is stored. Since Internet servers are interconnected to many other servers, there may well be many different paths over which access to the required Internet server can be made. The URL will contain no information relating to firewalls or other relays which may be within the connection route between the source and destination computers.

In this embodiment, in order to be able to establish secure data connections with the first and second firewalls 11, 45 (since these are ‘secure’ firewalls), a special protocol is used between the first, second and third client computers 5, 7, 9 and the firewalls, as will be explained below.

Returning to the situation shown in FIG. 1, if a user at the first client computer 5 enters the URL of a web-site stored on the web-site server 47 into an Internet browser running on the first client computer, that computer will then attempt to make a connection with the destination server (the web-site server). This will result in the first client computer opening a socket (socket 1) with the first firewall 11 and then sending a CONNECT message to the first firewall 11 along with information pertaining to the host, the port and the URL. Had the first firewall 11 been a simple (non-secure) relay, the first firewall would simply return an OK message to the first client computer (confirming the connection) and would have proceeded to repeat the previous step, i.e. attempting to connect with the web-site server 47 (and possibly coming across further relays etc). However, since the first firewall 11 is a secure relay, the firewall returns a SECURE message to the first client computer 5. In response to this, the first client computer opens a first SSL session ‘sSL1’ over socket1. The user at the first client computer 5 then re-sends the CONNECT message (this can be performed automatically), using the SSL1 session, to the first firewall 11 which then decides whether to allow the connection request to continue, or whether to reject the request, based on pre-stored criteria. If the request is rejected, a REJECT message is returned to the first client computer. If the request is allowed, the URL is forwarded for determining the next connection point in the path to the destination address. Since the second firewall 45 is present in FIG. 1, the above process will repeat, i.e. a socket (socket2) will be established between the first firewall 11 and the second firewall 45, a CONNECT message will be relayed from the first client computer 5 to the second firewall 45 (via the SSL1 session), a SECURE message returned from the second firewall 45, a new SSL session (SSL2) invoked between the first client computer 5 and the second firewall 45, and so on. Assuming this second firewall 45 is traversed successfully, the next connection point in the path is the web-site server 47. Since the URL can be accessed from here, a simple OK acknowledgement message is returned from the web-site server to confirm to the first client computer 5 that the connection has been made. The web-site referenced by the URL can be accessed via a new SSL connection (SSL3) which is invoked on a new socket (socket3) established between the second firewall 45 and the web-site server 47.

The process by which the various SSL sessions, i.e. SSL1, SSL2 and SSL3 are set-up will be described with reference to FIG. 2.

Referring to FIG. 2, the layered processes running on the various system components of FIG. 1 are shown. As mentioned above, initially, socket1 (indicated by reference numeral 15) is set up between the first client computer 5 and the first firewall 11, socket2 is set up between the first firewall 11 and the second firewall 45, and socket3 is set up between the second firewall 45 and the web-site server 47. As mentioned previously, a ‘socket’ is the standard interface by which data is transferred on the transport level of a computer network. Since SSL requires an end-to-end connection between devices in order to operate, the first SSL session (SSL1) can operate on socket1 as its transport layer. In order for SSL2 to operate between the first client computer 5 and the second firewall 45 (as is required in the above example) then SSL2 uses SSL1 as its transport layer. This is represented by the fact that SSL2 ‘sits’ on SSL1 on the first end of the SSL2 session represented in FIG. 2. In a similar manner, SSL3 uses SSL2 as its own transport layer. This use of previous SSL sessions as transport layers is made possible by using the Java Secure Sockets Extension (JSSE) implementation of SSL, since JSSE uses an abstract view of the sockets layer in neutrons.

SSL3 is used to effect secure data transactions between the first client computer 5 and the web-site server 47 at the destination computer, i.e. the web-site server 47. Such data transactions may involve requesting information, making a payment order to purchase goods, viewing banking information, and so on.

The above described protocol and method allows client computers to connect to destination computers without requiring any knowledge of the connection route to be taken, or of the number of secure relays along the connection route. Any number of secure relays can be traversed. It is possible that a single relay may act as a contact point for several servers. Thus, two different URLs may be referenced by the same relay, and so it may be desirable to reuse previously established sessions. The above described protocol facilitates the reuse of SSL sessions. For example, if, once a connection and SSL session (SSL3) is established between the first client computer 5 and the web-site server 47, a check is made to see if a previous SSL session has been invoked between the same client computer and web-site server, then the new SSL session (SSL3) can be dropped, and the previous SSL session used instead. This can be facilitated by sending a public key (belonging to the user at the first client computer 5) with the CONNECT message and by returning the public key with the OK message when the connection is established. Either end of the connection can determine whether a session already exists. The principles behind SSL and public/private key encryption will be well known to the person skilled in the art, an example information source being currently found at the following web-site reference:http://home.netscape.com/security/techbriefs/ssl.html.

What is claimed is:

1. A method of establishing a data connection between a client computer and a destination computer over a computer network containing an unknown number of secure relays, the destination computer being identified at the client computer by an address, wherein the method comprises: (a) establishing data connections between successive connection points to form a connection path from the client computer to the destination computer, (b) in the event that a connection point in the path is a secure relay, using a secure data transfer protocol to supply the address to that connection point for onward transmission; and (c) repeating step (b) for any further secure relay in the connection path until the destination computer is reached.

2. A method according to claim 1, wherein, in step (b), in the event that the connection point in the path is a secure relay, that secure relay sends a request message to the client computer requesting a secure data transfer session between the client computer and that secure relay, and in response thereto, the client computer establishes a secure data transfer session with that secure relay.

3. A method according to claim 1, wherein, in stop (b), in the event that the connection point in the path is a secure relay, and that a secure data transfer session has previously been established between the client computer and a secure relay forming a previous point in the path, the client computer establishes a further secure data transfer session between the client computer and the subsequently located secure relay.

4. A method according to claim 2, wherein, in step (b), in the event that the connection point in the path is a secure relay, and that a secure data transfer session has previously been established between the client computer and a secure relay forming a previous point in the path, the client computer establishes a further secure data transfer session between the client computer and the subsequently located secure relay.

5. A method according to claim 3, wherein the further secure data transfer session between the client computer and the destination computer is layered over the or each previous secure data transfer session.

6. A method according to claim 3, wherein the further secure data transfer session between the client computer and the destination computer uses a previous secure data transfer session as its transport layer.

7. A method according to claim 1, wherein, when the destination computer is reached, the destination computer sends an acknowledgement message back to the client computer, whereafter the client computer establishes a further secure data transfer session between the client computer and the destination computer.

8. A method according to claim 7, wherein the method further comprises determining whether a secure data transfer session has been previously been established between the client computer and the destination computer; and in the event that such a secure data transfer session has previously been established, closing the most recently established secure data transfer session and commanding the client computer to transfer data using the previously established secure data transfer session.

9. A method according to claim 1, wherein the address at the client computer which identifies the destination computer is in the form of a URL.

10. A method according to claim 1, wherein the secure data transfer protocol is the SSL protocol.

11. A method of establishing a data connection between a client computer and a destination computer over a computer network containing an unknown number of secure relays, the destination computer being identified at the client computer by an address, wherein the method comprises: (a) establishing data connections between successive connection points to form a connection path from the client computer to the destination computer; (b) in the event that a connection point in the path is a secure relay: (i) sending a request message to the client computer requesting a secure data transfer session between the client computer and that secure relay, (ii) establishing a secure data transfer session between the client computer and that secure relay, and (iii) using the established secure data transfer session to supply the address to that secure relay for onward transmission; and (c) repeating step (b) for any further secure relay in the connection path until the destination computer is reached.

12. A method of establishing a data connection between a client computer and a destination computer over a computer network containing an unknown number of secure relays, the destination computer being identified at the client computer by an address, wherein the method comprises: (a) establishing data connections between successive connection points to form a connection path from the client computer to the destination computer; (b) in the event that a connection point in the path is a secure relay: (i) sending a request message to the client computer requesting a secure data transfer session between the client computer and that secure relay, (ii) establishing a secure data transfer session between the client computer and that secure relay, and (iii) using the established secure data transfer session to supply the address to that secure relay for onward transmission, the secure data transfer session being layered over any previously established secure data transfer session between the client computer and a secure relay forming a previous point in the path; and (c) repeating step (b) for any further secure relay in the connection path until the destination computer is reached.

13. A computer program stored on a computer usable medium, the computer program including computer readable instructions for causing a client computer to establish a data connection with a destination computer over a computer network containing an unknown number of secure relays, the destination computer being identified at the client computer by an address, the computer program causing the client computer to perform the steps of: (a) causing data connections to be established between successive connection points to form a connection path from the client computer to the destination computer, (b) in the event that a connection point in the path is a secure relay, using a secure data transfer protocol to supply the address to that connection point for onward transmission; and (c) repeating step (b) for any further secure relay in the connection path until the destination computer is reached.
